(19) United States
(12) Patent Application Publication
(10) Pub. No.: US 2012/0031347 A1
(43) Pub. Date: Feb. 9, 2012

(54) MULTI-CHAMBER LIVESTOCK BLOWER

(76) Inventors: Howard G. Denison, Keatchie, LA (US); Henry M. Craig, III, Bossier City, LA (US)

(21) Appl. No.: 12/849,582

(22) Filed: Aug. 3, 2010

(51) Int. Cl. A01K 13/00

(52) U.S. Cl. 119/606

(57) ABSTRACT

A livestock blower system, including a housing having one or more air inlets, a first blower chamber, a second blower chamber, and an air outlet in communication with the first blower chamber and the second blower chamber, wherein the air outlet provides for the expulsion of air from the first blower chamber and the second blower chamber onto livestock during use. A first blower assembly disposed inside the first blower chamber and a second blower assembly disposed inside the second blower chamber. The first and second blower assemblies receive air via the one or more air inlets and expel air via the air outlet.

### BACKGROUND

1. Field of the Invention

The present invention relates to blower systems and methods of use. More particularly, the invention relates to livestock blower systems and methods.

2. Description of Related Art

The appearance of livestock is important for displaying livestock at events such as shows, sales, and/or auctions. Livestock are often groomed (e.g., washed and dried) before such events so that the livestock presents the best possible appearance, helping to increase the value of the livestock. Blow drying the livestock may be beneficial during grooming as it typically makes the livestock's hair appear more voluminous and shiny. Often, blow drying is accomplished using traditional blow dryers designed for use by humans. Although these traditional blow dryers are readily available and easy to use and maneuver, they typically do not provide a sufficient flow of heated air. As a result, drying livestock using traditional blow dryers may result in undesirably long drying times and require the livestock to stay calm and still for long periods of time. In an attempt to address some of these concerns, some blower systems are designed specifically for use with livestock and are commercially available as an alternative to traditional hair dryers. However, the available livestock blower systems typically do not provide many characteristics and features that may be beneficial for grooming livestock.

In the case of grooming livestock, high temperature air is advantageous as it helps to clean and dry the animal's coat quickly and adds body or fluff to the hair. Moreover, in a livestock show environment, it is desirable that a livestock blower system is capable of heating air rapidly to a desired temperature to decrease the time needed for grooming the livestock. For example, during livestock shows, a contestant often has a limited amount of time to groom animals prior to judging. Further, in certain instances, an animal that has already been groomed may become dirty shortly before judging (e.g., the animal may lie down or a neighboring animal may defecate on the animal shortly before a showing). Accordingly, it may be desirable that a livestock blower system is capable of quickly heating air to the desired temperature such that grooming can be accomplished shortly after turning on the livestock blower system, effectively reducing the time needed for grooming.

Moreover, livestock blower systems are often used in dirty environments that include debris that can be drawn into and expelled from the livestock blower system. For instance, livestock blower system are often used in stalls lined with dirt, straw, and similar debris that can be sucked into and expelled from the livestock blower system. Unfortunately, the intake of debris into the livestock blower system typically causes additional wear on internal components, including blower/fan/heater assemblies housed therein. Moreover, debris that passes through the livestock blower system can be expelled in the stream of air and may be lodged into fur, eyes, and ears of the animal and persons close by. The presence of debris can cause the animal's coat to appear dirty, which is detrimental during judging of the livestock.

Further, livestock blower systems typically require maintenance, such as inspecting, cleaning, repairing, or replacing various components contained within the housing thereof. If maintenance is not performed as needed, a livestock blower system is likely to perform poorly or fail prematurely. Unfortunately, where the interior of the housing is not readily accessible, a user is less likely to perform regular inspection and maintenance. Moreover, when maintenance or repair is performed, additional complexity in accessing the components may increase the time and cost associated with the maintenance or repair. For example, a user may have to transport or send the entire system to a repair facility, thereby investing a great deal of time, effort and money.

In addition to the above concerns, when used to groom multiple animals, livestock blower systems are frequently moved from livestock from one location to another. For example, where a contestant has several animals in a single livestock show, the contestant often uses a single livestock blower system that is transported between stalls where each of the animals is located. Thus, a contestant may have to carry or otherwise move the livestock blower system from one location to any number of locations when grooming multiple animals.

Unfortunately, currently available commercial models may not be capable of providing many of these features, including but not limited to a sufficiently high pressure stream of heated air, rapidly heating the air to a desired temperature, and operating efficiently in debris filled environment. Moreover, existing models typically do not include readily accessible components, and often include large cumbersome units that make them difficult to move and maneuver around livestock.

Accordingly, it is desirable to provide a livestock blower system that is capable of providing at least the features of a high pressure stream of heated air, rapidly heating the air to a desired temperature, operating efficiently in a debris filled environment, includes accessible components, and/or is portable.

### SUMMARY

Various embodiments of livestock blower systems and related apparatus, and methods of operating the same are described. In some embodiments, provided is a livestock blower system, including a housing having one or more air inlets, a first blower chamber, a second blower chamber, and an air outlet in communication with the first blower chamber and the second blower chamber, wherein the air outlet provides for the expulsion of air from the first blower chamber and the second blower chamber onto livestock during use. A first blower assembly disposed inside the first blower chamber and a second blower assembly disposed inside the second blower chamber. The first and second blower assemblies receive air via the one or more air inlets and expel air via the air outlet.

In some embodiments, provided is a livestock blower system that includes a housing having one or more air inlets, a first blower chamber, a second blower chamber, a plenum to receive air from the first and second blower chambers, and an air outlet for the expulsion of air from the plenum onto livestock during use.

In some embodiments, provided is a livestock blower system that includes a housing having one or more air inlets, a first blower chamber, a second blower chamber, a plenum configured to receive air from the first and second blower chambers, and an air outlet that provides for the expulsion of air from the plenum onto livestock during use, a first blower assembly disposed inside the first blower chamber, and a second blower assembly disposed inside the second blower chamber. The first blower chamber includes a first elongated chamber and the second blower chamber includes a second elongated chamber. The first and second elongated chambers are disposed adjacent one another in a side-by-side configuration, and the first and second blower assemblies receive air via the one or more air inlets and expel air via the plenum and the air outlet.

### BRIEF DESCRIPTION OF THE DRAWINGS

Advantages of the present invention will become apparent to those skilled in the art with the benefit of the following detailed description and upon reference to the accompanying drawings in which:

FIG. 1 is a diagram that illustrates a perspective view of a livestock blower system in accordance with one or more embodiments of the present technique;

FIG. 1B is a diagram that illustrates a side view of the livestock blower system of FIG. 1 in accordance with one or more embodiments of the present technique;

FIG. 1C is a diagram that illustrates a top view of the livestock blower system of FIG. 1 in accordance with one or more embodiments of the present technique;

FIG. 2A is a diagram that illustrates a top-cross-sectioned view taken across line 2A-2A of FIG. 1B in accordance with one or more embodiments of the present technique;

FIG. 2B is a diagram that illustrates a side-cross-sectioned view taken across line 2B-2B of FIG. 1C in accordance with one or more embodiments of the present technique;

FIGS. 3A-3C are diagrams that illustrate end-views of alternate arrangements of chambers of the blower system in accordance with one or more embodiments of the present technique;

FIG. 4A is a diagram that depicts a side view of a cartridge assembly in accordance with one or more embodiments of the present technique;

FIG. 4B is a diagram that depicts an end view of a seating section of the cartridge assembly in accordance with one or more embodiments of the present technique;

FIG. 5A is a schematic diagram that illustrates the blower system including a valve in accordance with one or more embodiments of the present technique;

FIG. 5B is a schematic diagram that illustrates air flow from the valve to multiple chambers in accordance with one or more embodiments of the present technique; and

FIG. 6 is a diagram that illustrates a perspective view of the livestock blower system including an attachment in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique include a livestock blower system. In some embodiments, a livestock blower system includes a multi-chamber design. In certain embodiments, multiple chambers of the livestock blower system each includes one or more blower assemblies and/or heaters that pressurize and heat air flowing there through. In some embodiments, the chambers and blower assemblies are arranged to pressurize and heat streams of air in parallel. In certain embodiments, multiple chambers are provided adjacent one another in a side-by-side relationship. In some embodiments, streams of air pressurized and heated in parallel converge prior to being expelled from an outlet of the livestock blower system. In certain embodiments, streams of air expelled from the chambers are provided to a plenum, in which the steams of air mix and equalize in pressure and temperature before being expelled via an outlet of the livestock blower system. In some embodiments, the outlet includes a single aperture such that the pressurized and heated air of the multiple streams combine into a single stream of pressurized and/or heated air that is expelled from the livestock blower system via the single aperture. In some embodiments, a hose and/or nozzle is coupled to the outlet and may be used to direct air to livestock during use. In certain embodiments, a valve is provided to selectively redirect air back into one or more of the chambers for recirculation during use.

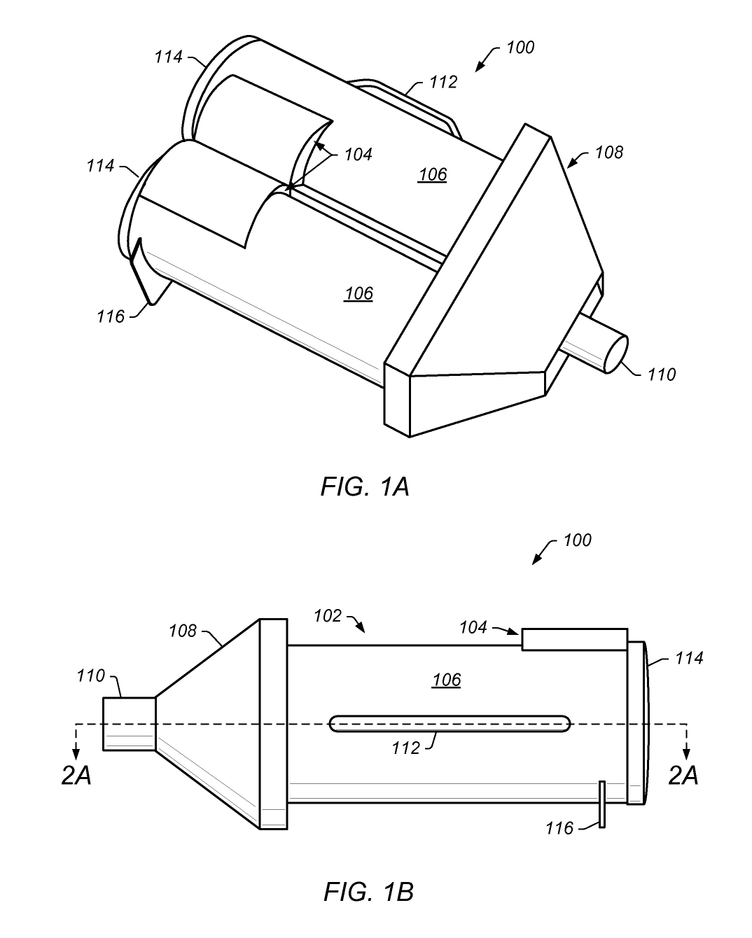

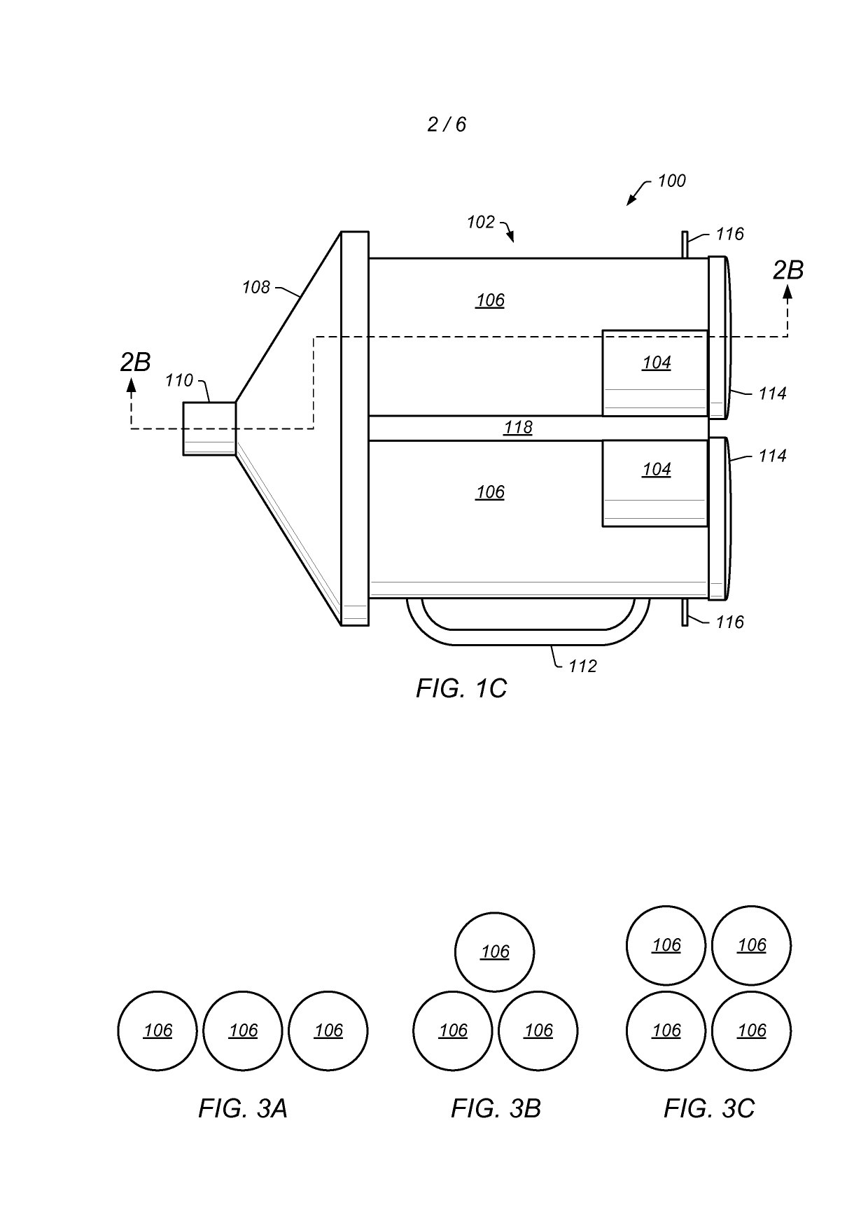

Turning now to the figures, FIGS. 1A, 1B and 1C are diagrams that illustrate a perspective view, side view and top view, respectively, of a livestock blower system (blower system) 100 in accordance with one or more embodiments of the present technique. FIG. 2A is a diagram that illustrates a top-cross-sectioned view taken across line 2A-2A of FIG. 1B in accordance with one or more embodiments of the present technique. FIG. 2B is a diagram that illustrates a side-cross-sectioned view taken across line 2B-2B of FIG. 1C in accordance with one or more embodiments of the present technique.

In some embodiments, blower system 100 includes a housing 102. Housing 102 may include one or more air inlets 104, one or more chambers 106, one or more plenums 108, and one or more air outlets 110. During use, air may be drawn into chambers 106 via inlets 104, the air may be pressurized and heated in parallel via blower assemblies located in the chambers 106, streams of the air may then be expelled from chambers 106 into plenum 108 where the steams of air mix before being expelled via outlet 110. In some embodiments, such a multi-chamber configuration may help to heat a greater volume of air to a high temperature quickly and efficiently.

Housing 102 may include a rigid structure that provides for the enclosure of various components of blower system 100. Housing 102 may be formed of metals, plastics, or any combination thereof. In certain embodiments, housing 102 is at least partially formed of stainless steel and/or aluminum. Aluminum may provide a lightweight, sturdy, and economical housing material. Aluminum may also resonant less sound from housing 102.

Housing 102 may include additional features such as a handle 112, end-caps 114, and base/feet 116. In some embodiments, a user may simply grasp handle 112 to provide for lifting or generally maneuvering of blower system 102. In some embodiments, handle 112 may include or be provided in combination with straps that enable blower system 100 to be carried like a backpack.

In some embodiments, end-caps 114 and or plenum 108 may be removable to provide for simplified access to an interior of housing 105 and chambers 106. For example, a user may simply slide-off end-cap 114 and/or plenum 108 to access an interior of chambers 106 for maintenance and/or repair of blower assemblies located within chambers 106. When maintenance and/or repair has been completed, the user may simply slide-on end-cap 114 and/or plenum 108. A removable end-cap 114 and/or plenum 108 may be removed without the need for special tools and/or significant disassembly of housing 102. For example, a user may unscrew or slide-off end-cap 114 and/or plenum 108 without the use of tools, or may simply loosen fasteners (e.g., screws) holding end-cap 114 and/or plenum 108 in place (e.g., using a screwdriver), but may not have to perform significant disassembly of housing 102, such as forcefully separating portions of housing 102 intended to remain fixedly joined to one another. A gasket or other sealing device may be used to inhibit air leakage between end-cap 114 and/or plenum 108 and housing 102. In some embodiments, end-cap 114 and/or plenum 108 is formed integral with housing 102, and may not be removable. For example, end-cap 114 and/or plenum 108 may be bonded to chambers 106 via welding or an adhesive.

In some embodiments, base/feet 116 may provide for supporting housing 102 against a supporting surface, such as a floor of stall lined with dirt, straw, and similar debris that can be sucked into blower system 100. In the illustrated embodiment, base/feet 116 include a plate that extends from a lower side of chambers 106 of housing 102. In the illustrated embodiment, the plate extends to about the same distance as the lower portion of plenum 108, such that blower system 100 may rest on the plate and plenum 108, thereby eliminating the need for additional base/feet 116 at or near plenum 108. In some embodiments, any variety and number of base/feet 116 may be provided. For example, an additional plate or feet may be provided in a mid-section or front end of chamber 106, proximate or at plenum 108.

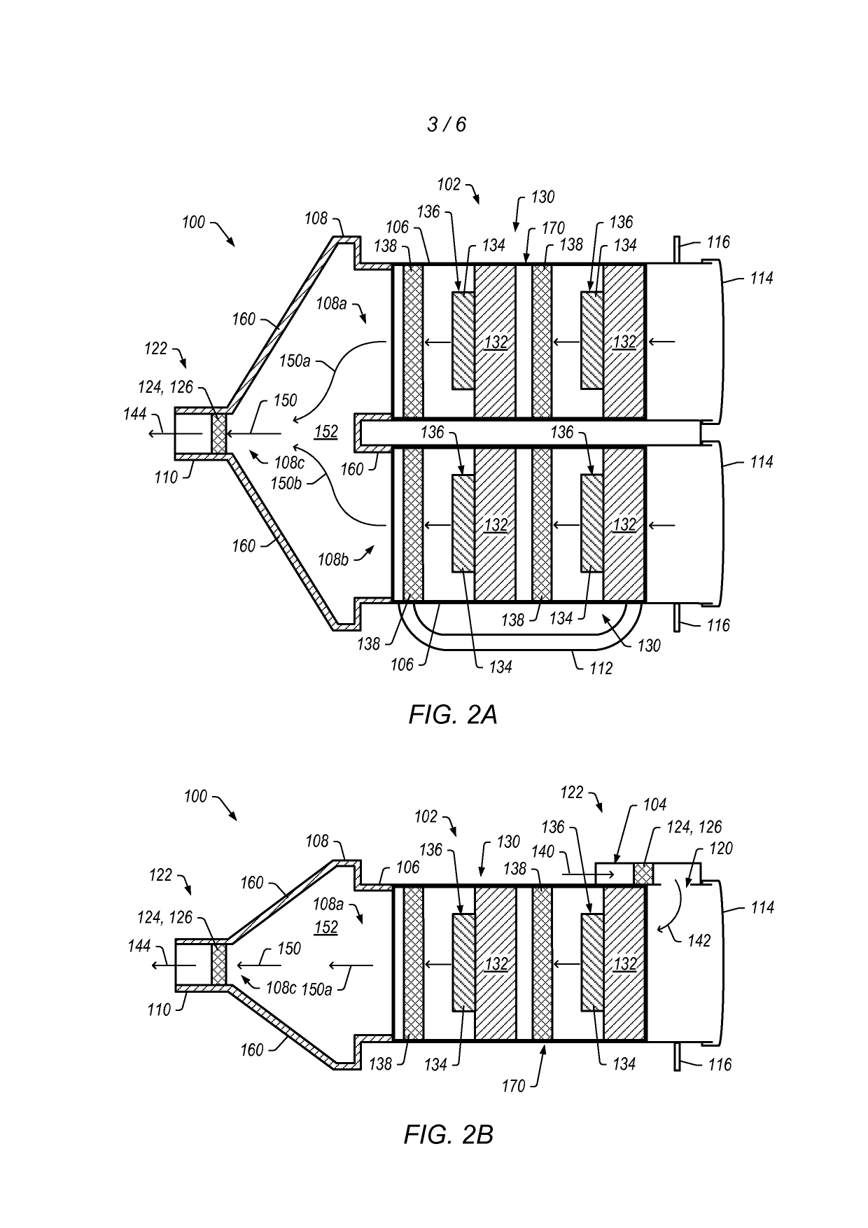

In some embodiments, chambers 106 include elongated chambers. For example, in the illustrated embodiment, chambers 106 each include elongated cylindrical tubes. In some embodiments, chambers 106 may include any cross-sectional shape desired, including but not limited to circular, elliptical, rectangular, square and triangular. In some embodiments, chambers 106 are disposed in a side-by-side relationship with one another. For example, in the illustrated embodiment, chambers 106 includes cylindrical tubes arranged adjacent one another in a side-by-side relationship such that the longitudinal axis of each of chambers 106 is offset from and substantially parallel with one another. In some embodiments, chambers 106 may be coupled to one another via a member 118 extending there between. For example, member 118 may include a plate and/or one or more struts that rigidly couple chambers 106 to one another. In some embodiments, the longitudinal axis of the chambers may be angled (e.g., oblique) to one another. Although the illustrated embodiment depicts two chambers 106, other embodiments may include any number of chambers. For example, embodiments of blower system 100 may include three or more chambers 106. In some embodiments, additional chambers may be provided in a side-by-side relationship with other chambers such that the longitudinal axes of the chambers reside on the same plane. For example, three or more chambers may be provided in a side-by-side relationship as depicted by an end-view of chambers of blower system 100 provided in FIG. 3A in accordance with one or more embodiments of the present technique. In some embodiments, additional chambers may be provided in a stacked relationship such that the longitudinal axes of one or more of the chambers do not reside on the same plane with the longitudinal axes of two or more of the other chambers. For example, three or more chambers may be stacked in a triangular configuration as depicted in FIG. 3B or four or more chambers may be stacked atop one another in a rectangular configuration as depicted in FIG. 3C.

In some embodiments, air inlets 104 include one or more opening that allow for the passage of air into one or more of chambers 106. For example, in the illustrated embodiment, blower system 100 includes two air inlets 104 located on an exterior surface of chambers 106. In some embodiments, air inlets 104 may include separate conduits for routing air into chambers 106. For example, in some embodiments, inlet 104 located on the surface of the left chamber 106 may define a channel/conduit that is separate from a channel/conduit defined by air inlet 104 located on the surface of the right chamber 106. In such an embodiment, each of the air inlets 104 may provide for the routing of air to a respective chamber inlet 120 (See FIG. 2B) of chambers 106. Chamber inlet 120 may include an opening in housing 102 and/or wall of chamber 106 that enables the passage of air into chamber 106. In some embodiments, air inlet 104 may include a common conduit for routing air into multiple chambers 106. For example, in some embodiments, a single inlet 104 located on the surface of chambers 106 may include a single-shared channel/conduit located on the surface of the right and/or left chambers 106. In such an embodiment, each of the common/shared air inlets 104 may provide for the routing of air to chamber inlets 120 of both chambers 106. Thus, a single air inlet 104 may be provided to route air to multiple chambers 106. In the illustrated embodiment, air inlets 104 each include a crescent shape. Inlets 104 may include any cross-sectional shape desired, including but not limited to circular, elliptical, rectangular, square and triangular.

In some embodiments, air inlets 104 may be located on an upper/top surface of housing 102. For example, in the illustrated embodiment, intakes 104 are located above a horizontal midline of housing 102. In some embodiments, the upper/top surface of housing 102 may be defined as opposite a portion of housing 102 that includes base/foot 116. In some embodiments, air inlet 104 may be located on an uppermost surface of housing 102. In certain embodiments, air inlet 104 is located distal or away from ends of housing 102. For example, an open end of air inlet 104 may be proximate a longitudinally central region of housing 102. In some embodiments, air inlet 104 maybe located at a laterally central region of housing 102. For example, in the illustrated embodiment, a majority of each of air inlets 104 is located in a between vertical midlines of each of chambers 106 in a depression located between chambers 106 such that substantially all of air inlets 104 are located proximate a laterally central region of housing 102. Such embodiments, having air inlets 104 located on an upper/top surface of housing 102 and/or in or near a central region of housing 102 may help to prevent debris or other contaminates from being drawn into blower system 100 via air inlets 104. For example, when base/foot 116 of blower system 100 is placed on a supporting surface (e.g., a floor), air inlets 104 may be disposed away from the supporting surface and be blocked from a direct path (e.g., a line of sight) to the supporting surface by housing 102 such that debris or other contaminates are less likely to be drawn into air inlets 104, thereby helping to reduce the amount of dust or other particles entering blower system 100. Dust and other particles may foul blower system 100. For example, dust and other particles may block or clog motors, fans, heaters, filtering systems, air inlets, and/or air outlets.

Air outlet 110 may include one or more openings, channels, nozzles or other conduit for directing out of housing 102 and/or focusing air towards livestock. Air outlet 110 may include an opening having any cross-sectional shape desired, including but not limited to circular, elliptical, rectangular, square and triangular. In the illustrated embodiment, air outlet 110 includes a cylindrical shaped conduit extending from plenum 108. Air outlet 110 may include a conical shape, frusto-conical shape, cylindrical shape, or the like. In certain embodiments, air outlet 110 may include a nozzle or have a nozzle coupled thereto. In some embodiments, air outlet 110 may be coupled to or formed integrally with plenum 108.

In certain embodiments, a cross-sectional area of outlet 110 is smaller than or approximately the same as a cross-sectional area of air inlet(s) 104. Air outlet 110 having a cross-sectional area smaller than the cross-sectional area of air inlet 104 may increase the pressure or velocity of air expelled from air outlet 110. Increasing the pressure or velocity of air expelled from blower system 100 may reduce livestock drying times and/or increase volume added to livestock hair. In certain embodiments, the cross-sectional area of outlet 110 is about or less than about 30%, 50%, 60%, 75%, 90%, or 95% of the cross-sectional area of inlet 104.

In some embodiments, blower system 100 may include a filter system 122. Filter system 122 may be coupled to air inlets 104 and/or air outlet 110. In certain embodiments, filter system 122 includes a filter 124 and/or a muffler 126. Filter system 122 may inhibit passage of debris or other particles through blower system 100. In certain embodiments, filter system 122 inhibits particles greater than a predetermined size from passing into and/or through blower system 100. Filtering particles may inhibit or reduce the potential for damage to blower system 100 by filtering particles that may otherwise foul and/or damage components of blower system 100. In certain embodiments, filter 124 includes fiberglass, paper, plastics, metals such as stainless steel or aluminum, a fine mesh material, a multilayer filter and/or a High Efficiency Particulate Air filter (a “HEPA filter”).

In some embodiments, muffler 126 may reduce or inhibit sound from exiting blower system 100 and/or reduce the sound of operating blower system 100. In some embodiments, muffler 126 may dampen, absorb, and/or destroy sound waves generated within blower system 100. In some embodiments, muffler 126 may be designed such that opposite moving sound waves are likely to collide and cancel each other out. For example, muffler 126 may include a resonating chamber. In certain embodiments, muffler 126 includes baffles that reduce sound emitted from blower system 100.

In some embodiments, chambers 106 each include a blower assembly 130 disposed therein. Blower assemblies 130 may include one or more fans 132 and/or one or more motors 134. For example, in the illustrated embodiment, each of blower assemblies 130 includes two fan assemblies 136, each including a fan 132 and motor 134. Motor 134 may include an electric or other type of motor that drives/actuates fan 132 coupled thereto. In certain embodiments, motors 140 are thru-flow discharge motors. For example, motors 140 may be Ametek® Lamb Electric (Kent, Ohio) model no. 115923.

Blower assemblies 130 may produce or assist in producing a air flow through blower system 100. For example, fan assemblies 136 may compress or pressurize air as it passes through fans 132. Compressing the air may increase the temperature of the air passing through the fan, thereby heating the air. In some embodiments, operation of fans 132 and/or motors 134 may produce heat, thereby heating the air as it passes through fan assemblies 136. In some embodiments, the air may be heated as a result of compressing the air and/or the heat produced by fans 132 and/or motors 134. In some embodiments, a heater 138 may be provided to assist in heating the air. For example, in the illustrated embodiment, blower assemblies 130 include a heater 138 located downstream of each of fan assemblies 136. Heaters 138 may include an electric resistance heater or the like. Any number of heaters 138 may be provided. In some embodiments, the air may be heated without the use of a heater or heating element. For example, blower system 100 may not include any of heaters 138. In such an embodiment, the air may be heated only or at least substantially by compressing the air and/or the heat produced by fans 132 and/or motors 134. Such an embodiment may be particularly beneficial as no additional heating elements may be required, thereby reducing the complexity of blower system 100.

In some embodiments, fan assemblies 136 are provided in series or parallel. For example, in the illustrated embodiment, each of chambers 106 includes two fan assemblies 136 arranged in series along a length of chamber 106 such that air passes through the two fans 132 of each fan assembly 136 sequentially, one after the other.

Operation of fans assemblies 136 may generate airflow through blower system 100. For example, during operation, air from the surrounding atmosphere or another air source may be drawn into and through inlet 104 (as depicted by arrow 140 of FIG. 2B) and chamber opening 120 (as depicted by arrow 142), pass through fans 132 within chambers 106, and may be expelled from housing 102 via outlet 110 (as depicted by arrows 144). In some embodiments, streams of air from two or more chambers 106 are routed into plenum 108. The steams of air may mix and equalize in pressure and/or temperature within plenum 108 before being expelled via outlet 110 of blower system 100. For example, as depicted in FIG. 2A, a first air stream 150a that is routed through a blower assembly 130 of one of chambers 106 and a first inlet 108a of plenum 108, and a second air stream 150b that is routed in parallel through another blower assembly 130 of another one of chambers 106 and a second inlet 108b of plenum 108 are routed into an interior space 152 defined by plenum 108. Within interior space 152, air streams 150a and 150b may mix with one another, thereby equalizing in pressure and/or temperature within plenum 108 to form a single-combined air stream 150 that is expelled via a plenum outlet 108c to outlet 110. Interior space 152 may include a variety of shapes and configurations. In the illustrated embodiment, for example, interior space 152 includes a pyramidal shaped volume defined by a pyramidal shape of plenum 108. Other shapes may include, but are not limited to, triangular, rectangular, cubic, hemispherical, and conical. In some embodiments, each of air streams 150a and 150b may originate from one of inlets 104 and pass through separate chamber openings 120 of chambers 106.

In some embodiments, blower system 100 may include an insulated region, such as insulation 160 disposed on or near interior walls/surfaces of housing 102. Insulation 160 may inhibit heat loss, thereby retaining heat to facilitate heat transfer to air (e.g., air streams 150, 150a and 150b) proximate insulation 160. In some embodiments, insulation 160 may include natural materials, synthetic materials, or combinations thereof. Insulation 160 may include petrochemical products or byproducts, plastic, metal, fibers such as wool, cellulose, fiberglass and/or synthetic fibers (such as plastic fibers or recycled plastic fibers), and/or ceramic material. In certain embodiments, insulation 160 may include a coating disposed on surfaces of blower system 100.

As depicted in FIGS. 2A and 2B, blower system 100 may include an insulation 160 disposed on interior walls of outlet 110, plenum 108, and/or chamber 106. In some embodiments, insulation 160 may be provided only on portions of housing 102 downstream of fan assemblies 136 and/or heaters 138. Such embodiments may inhibit loss of heat from air streams 150, 150a and 150b after they have been heated and prior to being expelled via outlet 110. In some embodiments, insulation 160 may be provided on portions of housing 102 upstream, adjacent, and/or downstream of fan assemblies 136 and/or heaters 138. For example, insulation 160 may be provided on all or substantially all of interior surfaces of housing 102 (e.g., insulation 160 disposed on interior walls of outlet 110, plenum 108, chamber 106 and end-cap 114). Such embodiments may inhibit loss of heat from air streams 150, 150a and 150b before and after they have been heated, and prior to being expelled via outlet 110. Such embodiments may be particularly beneficial where heated air is recirculated for additional heating. In certain embodiments, insulation 160 may reduce or eliminate the need for a heater within the blower system 100.

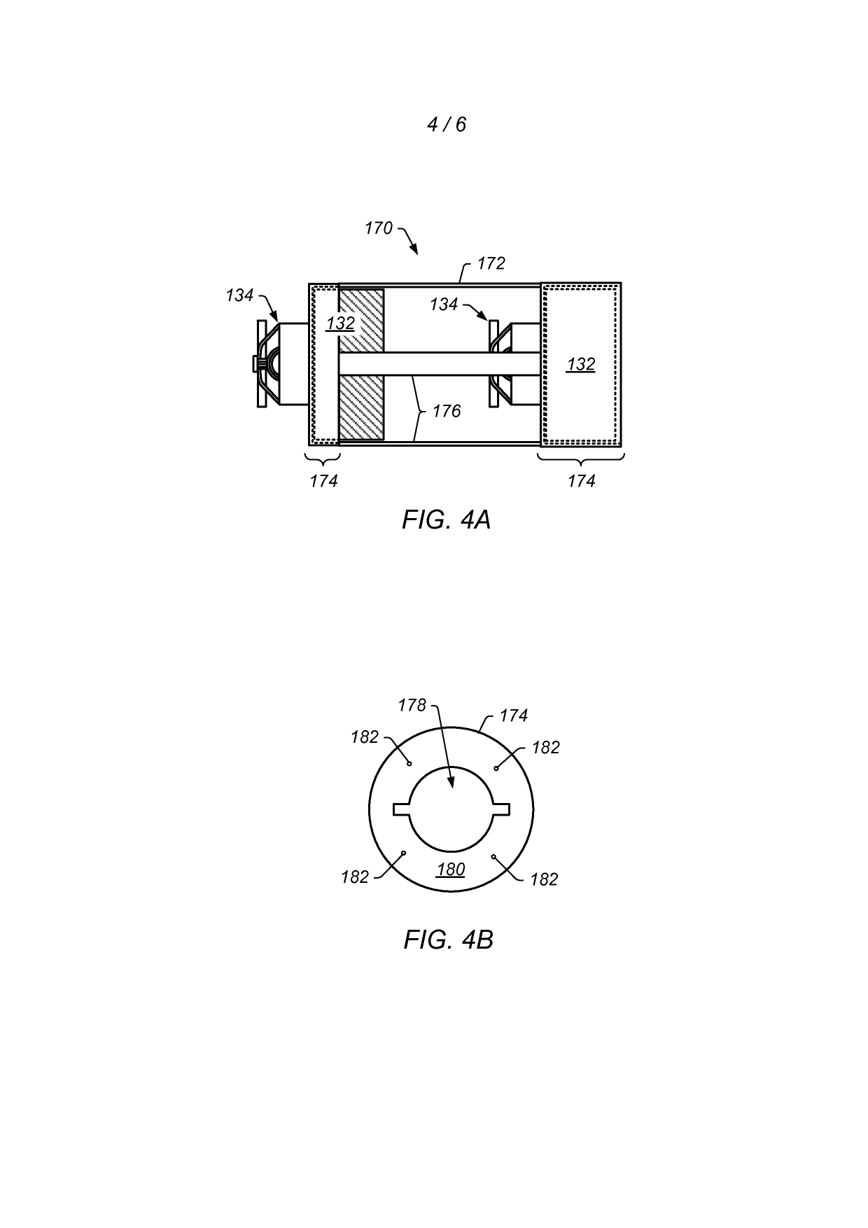

In some embodiments, blower assemblies 130 may be provided as part of a cartridge assembly 170. Cartridge assembly 170 may be removable as a single unit from within housing 102, thereby simplifying inspection and maintenance of components of blower system 100. FIG. 4A depicts a side view of a cartridge assembly 170 in accordance with one or more embodiments of the present technique. In the illustrated embodiment cartridge assembly 170 includes fans 132 and motors 134 coupled to a cartridge frame 172. Fans 132, motors 134 and heaters 138 may be coupled to cartridge frame 172 such that they can be manipulated as a single unit. Cartridge frame 172 may be designed to couple to and house any number of fans 132, motors 134, heaters 138 or other components of blower system 100. In the illustrated embodiment, two single units of fans 132 and motors 134 are coupled to cartridge frame 172.

In some embodiments, cartridge frame 172 may have one or more seating sections 174 to provide for seating and retention of fans 132, motors 134 and/or heaters 138 within cartridge frame 172. Struts 176 or other connection members may couple together seating sections 174 of cartridge frame 172. In certain embodiments, struts 176 are welded, brazed or otherwise bonded to seating sections 174 to couple them together.

FIG. 4B depicts an end view of a seating section 174 of the cartridge assembly 170 in accordance with one or more embodiments of the present technique. Seating section 174 may have an opening 178 sized such that motor 134 may pass through the opening and fan 132 seats against wall 180 of seating section 174 surrounding opening 178. Fan 132 and motor 134 may be coupled to (e.g., mounted to) seating section 174 of cartridge frame 172 by fastening fan 132 and motor 134 to seating section 174. For example, screws or other fasteners may mount fan 132 and motor 134 to cartridge assembly frame 172 using openings 182. Cartridge assembly 155 may have other openings and or passages for allowing wiring associated with fans 132 and motors 134 to pass through or out of the cartridge assembly. Fan 132 and/or motor 134 may seat against the walls of cartridge frame 172 such that little or no air leaks around fan 132 and motor 134. Inhibiting air leaks around fan 132 and motor 134 inhibits air recirculation within cartridge assembly 170 that may cause a reduction in velocity or power of air exiting the blower system 100.

Cartridge assembly 170, with fans 132, motors 134 and/or heaters 138 coupled to cartridge frame 172, may be mounted in housing 102, as depicted in FIGS. 2A-2B. In certain embodiments, cartridge assembly 170 is placed in and secured within housing 102 using screws or other fasteners. For example, cartridge assemblies 170 may slide into chambers 106 of housing 102 through open ends of housing 102 that are exposed when end-caps 114 are removed. Cartridge assembly 170 may be and fastened to chambers 106 of housing 102 using screws coupled to the walls of chambers 106. In certain embodiments, end-caps 114 and or plenum 108 may be removed to allow cartridge assemblies 170 to be inserted and/or removed from housing 102 as a single unit.

In certain embodiments, a sealing material is used to create a seal between the outer walls of cartridge assembly 170 and the inside walls of chambers 106 of housing 102. In certain embodiments, a gasket or o-ring is provided to create a seal between cartridge assembly 170 and the inside walls of chambers 106 of housing 102. The gasket may include, for example, a silicone gasket. In some embodiments, a silicone bead or a bead of another suitable material is placed between the outer walls of cartridge assembly 170 and the inside walls of chambers 106 of housing 102 to create a seal. The seal between the outer walls of cartridge assembly 170 and the inside walls of chambers 106 of housing 102 inhibits air recirculation inside chambers 106 of housing 102. Air recirculation inside chambers 106 of housing 102 may cause a reduction in velocity or power of air exiting the blower system. The seal may be broken during use (e.g., maintenance) to remove cartridge assembly 170 from housing 102. Upon re-insertion of cartridge assembly 170 or insertion of a new cartridge assembly, a new seal may be made between the newly inserted cartridge assembly and the inside walls of chambers 106 of housing 102.

Mounting motors 132, fans 134 and/or heaters 138 in housing 102 as part of a single unit cartridge assembly 170 allows simple removal and/or replacement of fans 132, motors 134 and/or heaters 138. For example, cartridge assembly 170 may be removed from housing 102 and a new cartridge assembly placed in the housing with one or more new motors, fans and/or heaters coupled to the new cartridge assembly. Fans 132, motors 134 and/or heaters 138 on the removed cartridge assembly 170 may be replaced with new motors, fans and/or heaters and cartridge assembly 170 may be placed back in housing 102.

In some embodiments, blower system 100 includes an airflow path that includes a turn within housing 102. Turning and/or deflecting the air may increase the velocity with which the flow of air travels through housing 102. Increasing the velocity of air within housing 102 may increase the velocity and/or power of air expelled from air outlet 110. In some embodiments, the air flow path turns within housing 102. In certain embodiments, the air flow may turn at least approximately 90 degrees, at least approximately 180 degrees, or at least approximately 270 degrees in direction prior to passing through blower assemblies 130. For example, in the illustrated embodiment, an air stream enters inlet 104 in a first direction (depicted by arrow 140), the air stream turns approximately 90 degrees as it is deflected by an enclosed end of inlet 104, passes through chamber inlet 142 and is deflected by a curved internal surface of end-cap 114 and walls of chamber 106 by an additional approximately 90 degrees (as depicted by arrow 142) prior to entering blower assemblies 136.

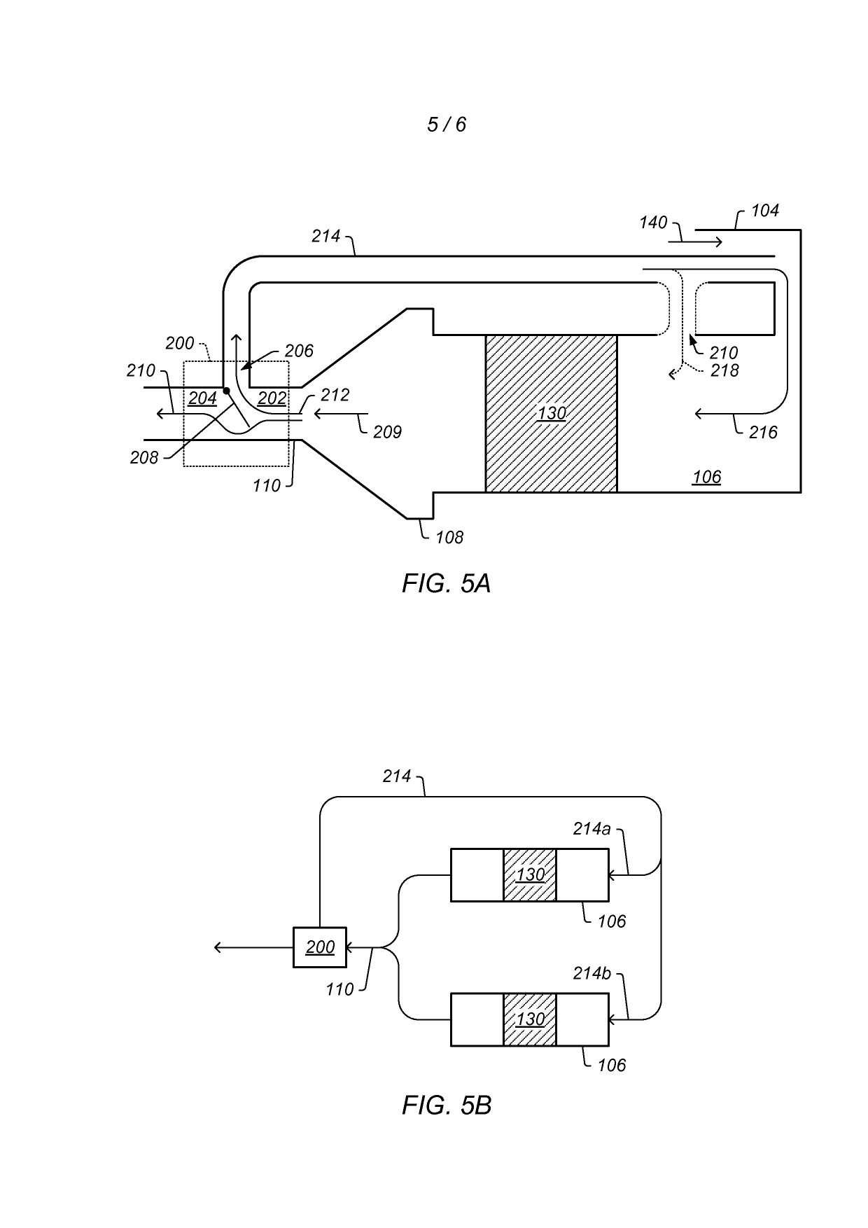

In some embodiments, blower system 100 includes a valve 200 to selectively control and/or direct the flow of air exiting blower system 100. FIG. 5A is a schematic diagram that illustrates blower system 100 including a valve 200 in accordance with one or more embodiments of the present technique. In some embodiments, valve 200 is coupled to outlet 110. Valve may include an attachment coupled to outlet 110 or may include an integral component of valve 110. In some embodiments, valve 200 may be provided internal to plenum 108. In some embodiments, valve 200 may direct airflow for recirculation air within blower system 100. Recirculation of airflow may include routing air that has passed through blower assemblies 130 to a location upstream of one or more of blower assemblies 130 such that the air may be further compressed and/or heated via another pass through bower assemblies 130. For example, in the illustrated embodiment, valve 200 includes a valve air inlet 202 that includes a conduit communicatively coupled to outlet 110, a first valve air outlet 204 that includes a conduit for expelling air from blower system 100, a second valve air outlet 206 that includes a conduit for recirculating air back into blower system 100, and a valve mechanism 208 for regulating the amount of air passing through valve air inlet 202 that is routed to each of first and second valve outlets 204 and 206. In some embodiments, valve 200 may be adjustable such that none, some or all of the air passing through valve air inlet 202 is routed to one or the other of first and second valve outlets 204 and 206. For example, in the illustrated embodiment, valve mechanism 208 is positioned such that some of air passing through outlet 110 (depicted by arrow 209) exits blower system 100 (as depicted by arrow 210), and that some of air passing through outlet 110 (depicted by arrow 209) is recirculated to blower system 100 (as depicted by arrow 212). Where all or substantially all of the air passing through valve air inlet 202 is routed to first valve outlet 204, all or substantially all of the air may be routed to exit blower system 100. Where all or substantially all of the air passing through valve air inlet 202 is routed to second valve outlet 206, all or substantially all of the air may be recirculated within blower system 100. Valve 200 may be adjustable such that a user may select how much air (e.g., 0%-100%) exits blower system 100 or is recirculated into blower system 100. For example, a user may adjust a slider or dial to adjust valve mechanism 208.

In some embodiments, first valve outlet 204 may be coupled to a hose, nozzle, or similar conduit for directing air flow to livestock for grooming. In some embodiments, second valve outlet 206 may be coupled to a bypass conduit 214 for redirecting the air for recirculation within blower system 100. For example, in the illustrated embodiment, bypass conduit 214 directs the air into air inlet 104 (as depicted by arrow 216) for recirculation within blower system 100. In some embodiments, bypass conduit 214 may direct air direct the air directly into chamber 106 (as depicted by arrow 218) via a recirculation inlet 210 (depicted in dashed lines) for recirculation within blower system 100. Blower system 100 may employ one or both of bypass conduit 214 directing air into inlet 104 and/or directly into chamber 106 via one or more recirculation inlets 210.

Although the illustration of FIG. 5A is indicative of recirculation into one of chambers 106, it will be appreciated that the same or similar technique may be employed for a plurality of chambers 106 of blower system 100. FIG. 5B is a schematic diagram that illustrates air flow from valve 200 to multiple chambers 106 in accordance with one or more embodiments of the present technique. In some embodiments, one or more valves 200 may be used to recirculate air to two or more chambers 106, upstream of one or more blower assemblies 130. For example, in the illustrated embodiment of FIG. 5B, valve 200 may direct air into bypass conduit 214 which routes the air to chambers 106 upstream of blower assemblies 130 via conduits 214a and 214b. Conduits 214a and 214b may direct air into air into inlets 104 of chambers 106 and/or directly into chamber 106 via one or more recirculation inlets 210, as described above with regard to FIG. 5A.

Recirculating air into the blower system 100 may heat the air faster and/or to higher temperatures above ambient due to the air being repetitively and continually heated by system 100. Heating the air faster and/or to higher temperatures above ambient may be useful in colder climates where the ambient air temperature is low. Higher air temperatures may be more soothing and/or more comfortable for the livestock. After the air has been heated to a desired temperature by recirculating the air, valve 200 may be actuate to an opened/non-recirculate position to allow air (or more air) to exit blower system 100. For example, after the air is heated to the desired temperature with valve 200 in a closed/recirculate position, air for heating or grooming livestock may be provided through valve air outlet 204. In some embodiments, at least some air is continually recirculated to maintain desired air temperatures of air exiting valve air outlet 204. In some embodiments, the amount of air exiting valve air outlet 204 is controlled to provide a selected amount of air output from blower system 100. For example, the amount of air exiting valve air outlet 204 may be controlled by manipulating valve mechanism 208 to limit the pressure of air exiting system 100. Limiting the air output may help to prevent spooking livestock.

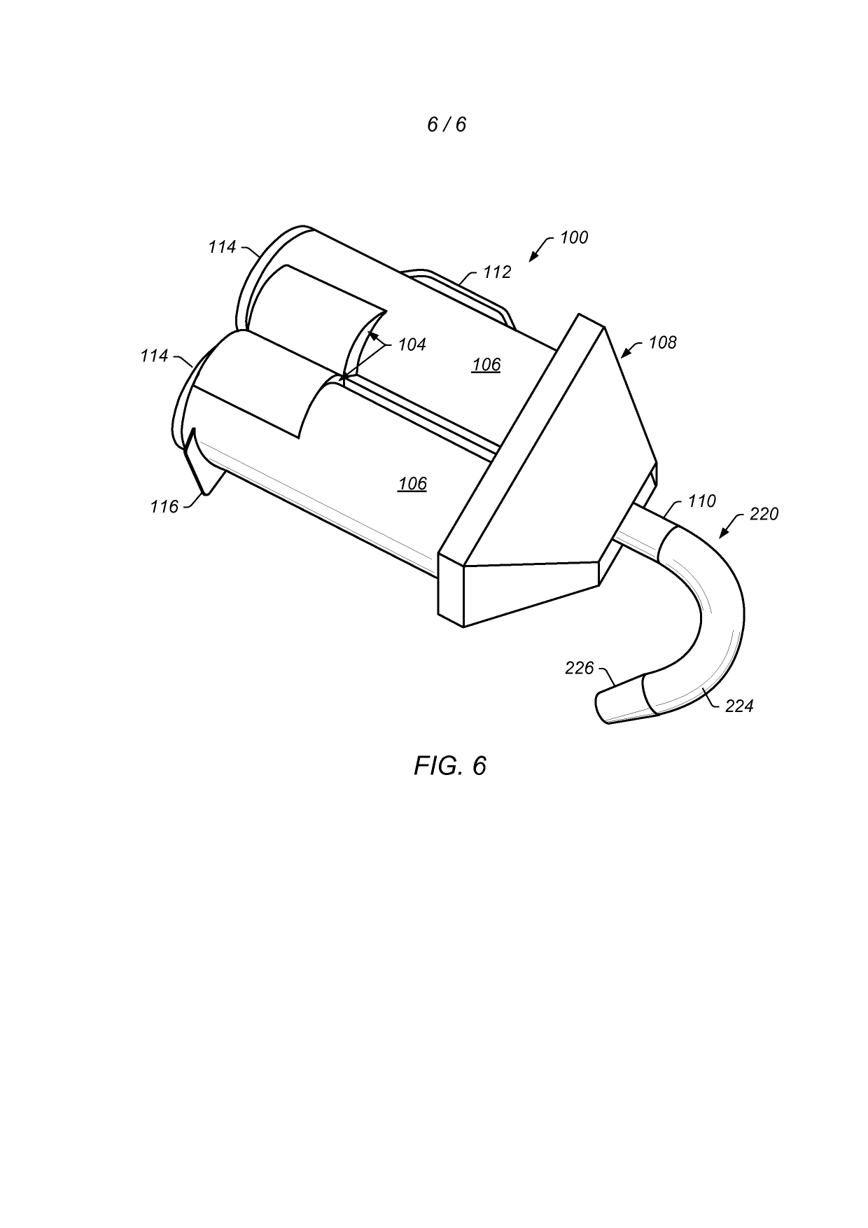

FIG. 6 is a diagram that illustrates a perspective view of livestock blower system 100 including an attachment 220 in accordance with one or more embodiments of the present technique. In the illustrated embodiment attachment 220 includes a flexible hose 224 having a nozzle 226 attached thereto. In some embodiments, an inlet of hose 224 may be coupled to outlet 110 and/or valve air outlet 204. In some embodiments, an inlet of nozzle 226 may be coupled to an outlet of hose 224 or may be directly coupled to outlet 110 and/or valve air outlet 204. In some embodiments, nozzle 226 may include various types and shapes to provide a desired airflow. In some embodiments, nozzle 226 may include features such as those disclosed and described in U.S. patent application Ser. No. 11/756,688 by Howard G. Denison and Henry M. Craig, III filed on Jun. 1, 2007 which is hereby incorporated by reference.

Further modifications and alternative embodiments of various aspects of the invention will be apparent to those skilled in the art in view of this description. For example, in some embodiments, blower system 100 may include other features, such as those disclosed and described in U.S. patent application Ser. No. 11/756,688 by Howard G. Denison and Henry M. Craig, III filed on Jun. 1, 2007 which are hereby incorporated by reference. For example, blower system 100 may include straps that enable blower system 100 to be carried like a backpack, legs, wheels, a cart, a nozzle having a wide narrow opening, a hollow palate nozzle for creating a whirlpool effect, an electrical supply box and/or wiring the same as or similar to that discussed in U.S. patent application Ser. No. 11/756,688.

Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Furthermore, note that the word “may” is used throughout this application in a permissive sense (i.e., having the potential to, being able to), not a mandatory sense (i.e., must). The term “include”, and derivations thereof, mean “including, but not limited to”. As used throughout this application, the singular forms “a”, “an” and “the” include plural referents unless the content clearly indicates otherwise. Thus, for example, reference to “a chamber” may include a combination of two or more chambers. The term “coupled” means “directly or indirectly connected”.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

What is claimed is:

1. A livestock blower system, comprising:
a housing, comprising:
one or more air inlets;
a first blower chamber;
a second blower chamber; and
an air outlet in communication with the first blower chamber and the second blower chamber, wherein the air outlet is configured to provide for the expulsion of air from the first blower chamber and the second blower chamber onto livestock during use;
a first blower assembly disposed inside the first blower chamber; and
a second blower assembly disposed inside the second blower chamber,
wherein the first and second blower assemblies are configured to receive air via the one or more air inlets and expel air via the air outlet.

2. The livestock blower system of claim 1, wherein the housing further comprises a plenum configured to route air from the first and second blower chambers to the air outlet of the housing.

3. The livestock blower system of claim 2, wherein the plenum comprises a first plenum air inlet configured to receive air expelled from the first blower chamber, a second plenum air inlet configured to receive air expelled from the second blower chamber, a plenum chamber configured to enable air expelled from the first and second blower chambers to mix and equalize in pressure, and a plenum air outlet configured to provide for expulsion of the mixed air to the air outlet of the housing.

4. The livestock blower system of claim 1, wherein the air is drawn into and expelled from the first blower chamber and the second blower chamber in parallel.

5. The livestock blower system of claim 1, wherein the air outlet comprises a single opening configured to route air expelled from both of the first and second blower chambers.

6. The livestock blower system of claim 1, wherein the first blower chamber comprises a first air inlet and the second blower chamber comprises a second air inlet.

7. The livestock blower system of claim 1, further comprising a hose coupled to the air outlet, wherein the hose is configured to direct air to livestock during use.

8. The livestock blower system of claim 1, wherein the first blower chamber comprises a first elongated chamber and the second blower chamber comprises a second elongated chamber, and wherein the first and second elongated chambers are disposed adjacent one another in a side-by-side configuration.

9. The livestock blower system of claim 8, wherein the one or more air inlets comprise a first air inlet located on an upper and laterally-central portion of an external surface of the first blower chamber and a second air inlet located on an upper and laterally-central r portion of an external surface of the second blower chamber.

10. A livestock blower system, comprising:
a housing, comprising:
one or more air inlets;
a first blower chamber;
a second blower chamber;
a plenum configured to receive air from the first and second blower chambers; and
an air outlet configured to provide for the expulsion of air from the plenum onto livestock during use.

11. The livestock blower system of claim 10, wherein the plenum comprises a first plenum air inlet configured to receive air expelled from the first blower chamber, a second plenum air inlet configured to receive air expelled from the second blower chamber, a plenum chamber configured to enable air expelled from the first and second blower chambers to mix and equalize in pressure, and a plenum air outlet configured to provide for expulsion of the mixed air to the air outlet of the housing.

12. The livestock blower system of claim 10, wherein the air is drawn into and expelled from the first blower chamber and the second blower chamber in parallel.

13. The livestock blower system of claim 10, wherein air outlet comprises a single opening configured to route air expelled from both of the first and second blower chambers.

14. The livestock blower system of claim 10, wherein the first blower chamber comprises a first air inlet and the second blower chamber comprises a second air inlet.

15. The livestock blower system of claim 10, further comprising a hose coupled to the air outlet, wherein the hose is configured to direct air to livestock during use.

16. The livestock blower system of claim 10, wherein the first blower chamber comprises a first elongated chamber and the second blower chamber comprises a second elongated chamber, and wherein the first and second elongated chambers are disposed adjacent one another in a side-by-side configuration.

17. The livestock blower system of claim 16, wherein the one or more air inlets comprise a first air inlet located on an upper and laterally-central portion of an external surface of the first blower chamber and a second air inlet located on an upper and laterally-central portion of an external surface of the second blower chamber.

18. The livestock blower system of claim 10, further comprising
a first blower assembly disposed inside the first blower chamber; and
a second blower assembly disposed inside the second blower chamber;
wherein the first and second blower assemblies are configured to receive air in parallel via the one or more air inlets and expel air via the air outlet.

19. A livestock blower system, comprising:
a housing, comprising:
one or more air inlets;
a first blower chamber;
a second blower chamber;
a plenum configured to receive air from the first and second blower chambers; and
an air outlet configured to provide for the expulsion of air from the plenum onto livestock during use;
a first blower assembly disposed inside the first blower chamber; and
a second blower assembly disposed inside the second blower chamber,
wherein the first blower chamber comprises a first elongated chamber and the second blower chamber comprises a second elongated chamber, and wherein the first and second elongated chambers are disposed adjacent one another in a side-by-side configuration, and
wherein the first and second blower assemblies are configured to receive air via the one or more air inlets and expel air via the plenum and the air outlet.

20. The livestock blower system of claim 19, wherein the one or more air inlets comprise a first air inlet located in a depression on an upper surface located between the first and second blower chambers.
